(19) United States
(12) Patent Application Publication
(10) Pub. No.: US 2016/0112786 A1
(43) Pub. Date: Apr. 21, 2016

(54) MICROPHONE HOLDER

(71) Applicant: KABUSHIKI KAISHA AUDIO-TECHNICA, Tokyo (JP)

(72) Inventor: Takashi MURATA, Tokyo (JP)

(21) Appl. No.: 14/872,635

(22) Filed: Oct. 1, 2015

(30) Foreign Application Priority Data
Oct. 17, 2014 (JP) 2014-212363

(51) Int. Cl. H04R 1/08; F16M 13/02; F16B 2/10

(52) U.S. Cl. CPC H04R 1/08; F16B 2/10; F16M 13/022; H04R 2201/025

(57) ABSTRACT

The microphone holder includes a holding portion that holds a microphone, and a mounting portion. The mounting portion includes a first clip member including a plate member locked with a lower face side of a rim, and a locking notch formed in the plate member, and locked with a shaft portion of a tension bolt, a second clip member including an insertion hole into which a head portion side of the tension bolt is inserted and locked, and a clip mechanism in which a pair of clamping members having the first clip member and the second clip member respectively formed in distal end portions, and arranged to face each other is rotatable around a support shaft, and the first and second clip members are biased in a direction of coming close to each other.

### BACKGROUND OF THE INVENTION

1. Field of the Invention

The present invention relates to a microphone holder, particularly to a microphone holder for a drum, a tom-tom or a snare drum, for example, on the rim of which a microphone is attached for collecting sound of a drum kit.

2. Description of the Related Art

When sound of a drum kit is collected in a recording studio or a live hall, for example, microphones are arranged to collect sound of each drum or other instrument. In this situation, a microphone is placed very close to the drum head, or the percussion surface, of the drum.

One of the methods of setting a microphone is use of a microphone stand. However, space for the microphone stand is limited because cables, amplifiers or lighting equipment are crowdedly placed around the drum kit. Therefore, conventionally a microphone is often held by a microphone holder provided on the rim of the drum. The rim made of metal having a ring shape is fitted over the edge of the drum.

A conventional microphone holder 40, as shown in FIGS. 15 and 16, often has a clip like structure having a microphone holding portion 41 or 42 which holds a microphone, and the holder pinches the rim 22 placed on the periphery of a tom-tom 20 from both upper and lower sides with biasing force of a spring provided in the holder.

With the clip like structure of the holding portion 41 or 42, however, the holder easily comes off due to lowering of the gripping force caused by long-term degradation of the spring. For example, the holder comes off due to misalignment of the holding portion caused by vibration of the drum during its performance. Japanese Unexamined Patent Application No.2009-94851 discloses a microphone holder including a base portion having a hook arm and a hook portion for clamping a rim from upper and lower sides. The hook portion that is at a lower portion and is freely slidable, is additionally fixed with a screw.

The rim holds and presses the periphery of the drumhead against the opening edge of a shell of the drum. By changing the pressing force to the rim, the tension of the drum head changes and tuning is achieved accordingly.

More specifically, the rim is screw-fixed against the shell with tension bolts configured at the plurality of positions on the circumference. As the bolts are tightened more strongly, the pressing force against the rim increases and the tension of the drum head becomes higher.

Thus the rim is temporarily fixed in the state that it can be pressed further.

However, when a microphone holder is attached with a clip or a hook to the rim, the total weight of the microphone and the microphone holder is locally applied to the rim, i.e. the microphone and the microphone holder are hanging from the fixing point on the rim. Consequently a problem arises that tuning may be adversely affected by the local displacement of the rim in the loading direction.

### SUMMARY OF THE INVENTION

The present invention has been made to solve the above problems, and an object thereof is to provide a microphone holder for holding a microphone to a drum, without having any effects on the tensioned state of a rim and adversely affecting tuning and sound collection.

To achieve the above-described object, a microphone holder according to the present invention includes: a holding portion adapted to hold a microphone; and a mounting portion coupled with the holding portion, and adapted to be mounted to a tension bolt for fixing a rim of a drum, the mounting portion including a first clip member including a plate member adapted to be locked with a lower face side of the rim, and a locking notch formed in the plate member and adapted to be locked with a shaft portion of the tension bolt, a second clip member arranged above the first clip member, and including an insertion hole into which a head portion side of the tension bolt is inserted and locked, and a clip mechanism in which a pair of clamping members having the first clip member and the second clip member respectively formed in distal end portions, and arranged to face each other is rotatable around a support shaft provided between the pair of clamping members, and the first clip member and the second clip member are biased in a direction of coming close to each other.

It is preferable that the locking notch included in the first clip member is a notch formed from one side surface side of the plate member.

In addition, it is preferable to include a pair of support leg portions provided in both right and left sides of the plate member of the first clip member, and adapted to abut on and support the drum side.

Moreover, it is preferable that the pair of support leg portions is formed of flanges provided extending from the both right and left sides of the plate member of the first clip member. Alternatively, the pair of support leg portions may be configured to include a pair of arm members having elasticity and provided extending from the first clip member side to the both right and left sides of the plate member, and a pair of abutting members provided on distal ends of the arm members.

With such a configuration, the microphone holder is fixed to the tension bolt, with which the tension of the drum head is adjusted, by the first and second clip members.

That is, since weight of the microphone is not loaded on the rim, tuning of the drum and sound collection can be performed without adversely affect the tension of the drum head.

In the microphone holder, with which the microphone is mounted to the drum, the microphone holder, the weight of which including the microphone do not affect the drum, and which does not cause a problem in tuning and the sound collection, can be obtained.

### BRIEF DESCRIPTION OF THE DRAWING

FIG. 1 is a perspective view illustrating a state in which a microphone is mounted to a tom-tom, using a microphone holder of the present invention;

FIG. 2 is a side view illustrating a partial side section of the microphone holder of the present invention;

FIG. 3 is a perspective view of the microphone holder of the present invention;

FIG. 4 is a perspective view of the microphone holder of the present invention, as viewed from a different angle from FIG. 3;

FIGS. 5A and 5B are perspective views illustrating a modification of a microphone of the present invention;

FIG. 6 is a perspective view illustrating a state in which a microphone holder of FIGS. 5A and 5B to a tom-tom;

FIGS. 7A and 7B are perspective views illustrating another modification of a microphone holder of the present invention;

FIG. 8 is an enlarged view of a portion where the microphone holder of FIGS. 7A and 7B is mounted to a tension bolt;

FIGS. 9A and 9B are perspective views illustrating another modification of a microphone holder of the present invention;

FIG. 10 is a perspective view illustrating a state where the microphone holder of FIGS. 9A and 9B is mounted to a tom-tom;

FIG. 11A is a side view illustrating another modification of a microphone holder of the present invention;

FIG. 11B is a rear view illustrating another modification of a microphone holder of the present invention;

FIG. 11C is a plan view illustrating another modification of a microphone holder of the present invention;

FIG. 12A is a side view of a state where the microphone holder of FIGS. 11A to 11C is mounted to a tom-tom;

FIG. 12B is a side view of a state where the microphone holder of FIGS. 11A to 11C is mounted to a tom-tom;

FIG. 13 is a side view (partial sectional view) illustrating a state where the microphone holder of FIGS. 11A to 11C is mounted to an opening portion of a horn of a wind instrument;

FIG. 14 is a perspective view illustrating a state in which the microphone holder of FIGS. 11A to 11C is mounted to an opening portion of a horn of a wind instrument;

FIG. 15 is a side view (partial sectional view) illustrating a state in which a conventional microphone holder is mounted to a tom-tom; and

FIG. 16 is a side view (partial sectional view) illustrating a state in which a conventional microphone holder is mounted to a tom-tom.

### DETAILED DESCRIPTION OF THE PREFERRED EMBODIMENTS

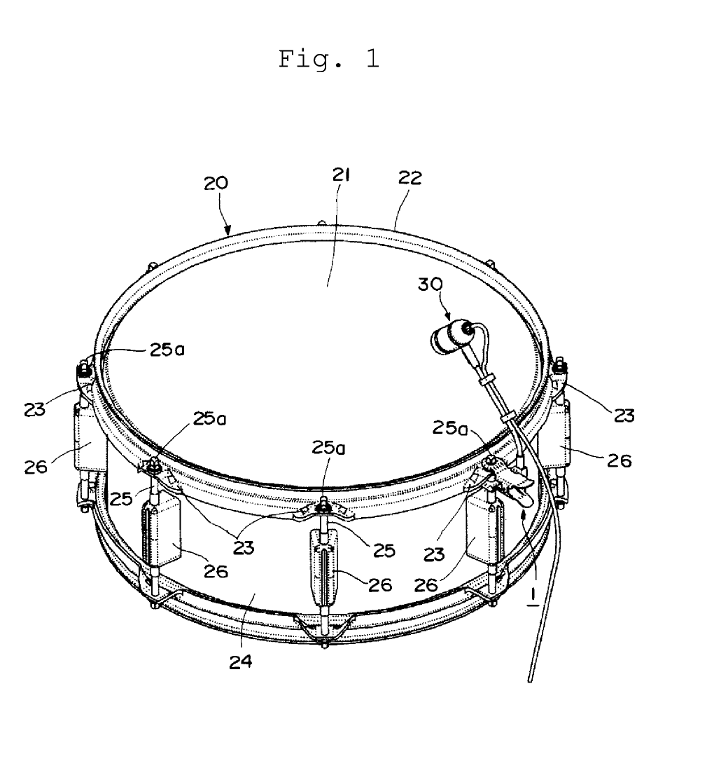

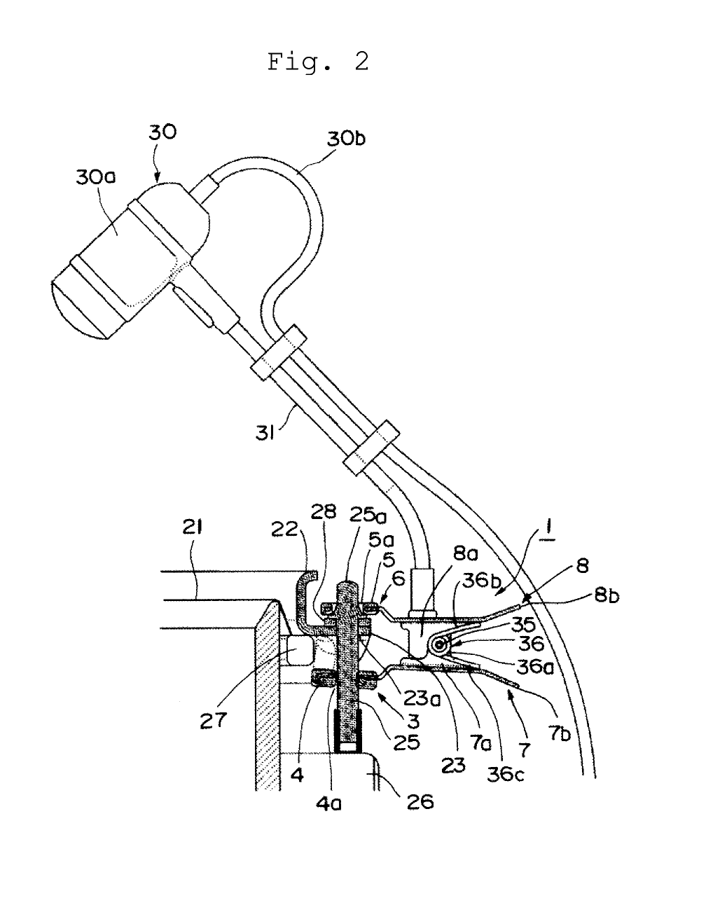

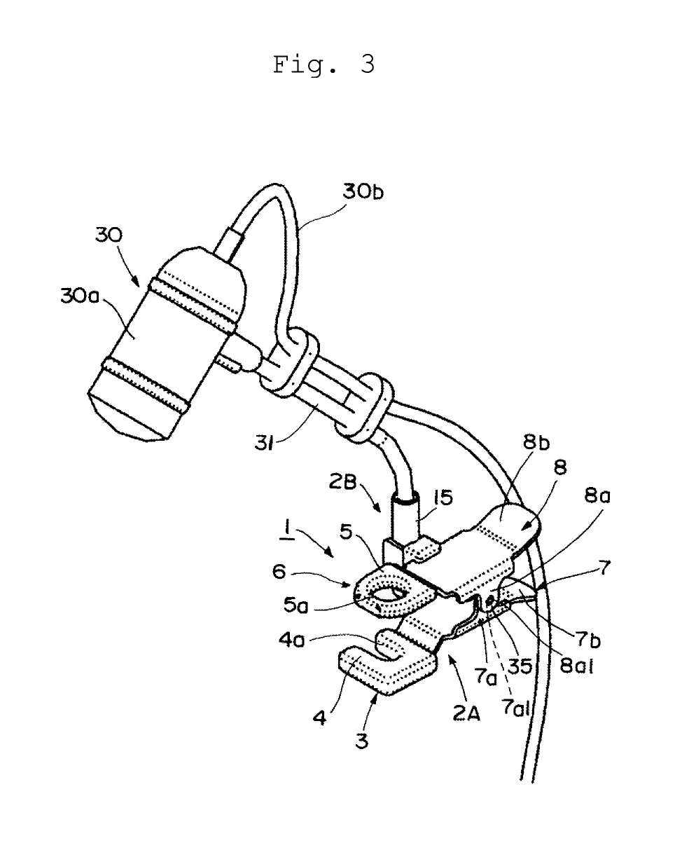

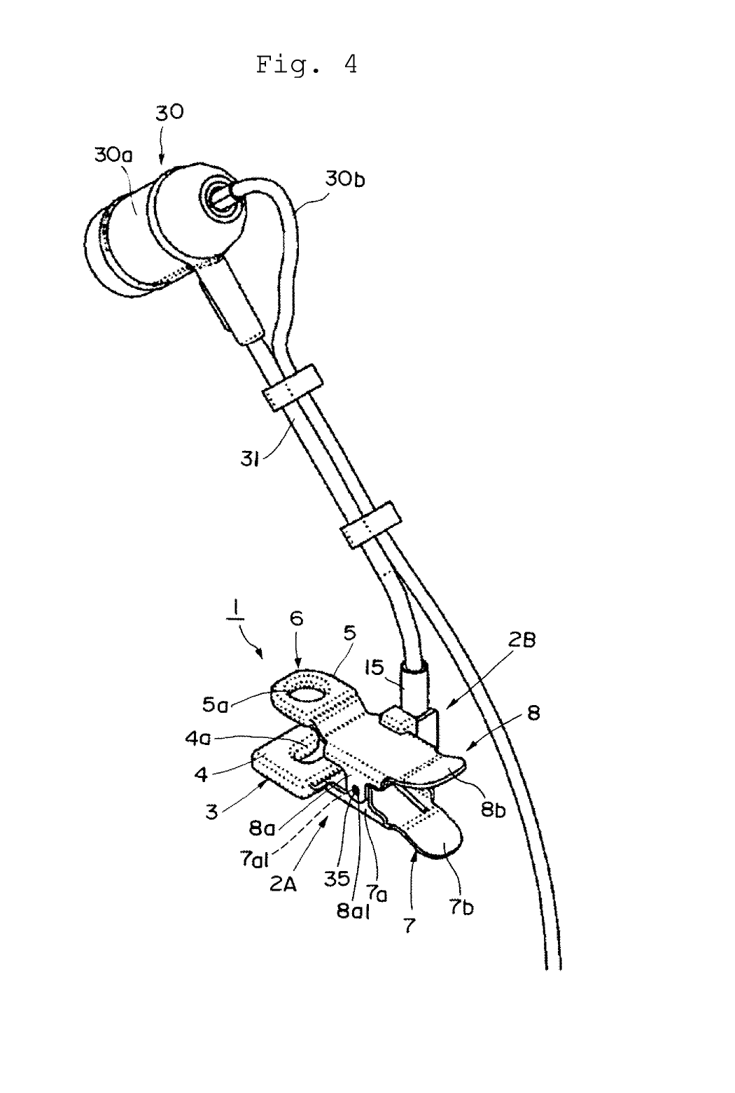

Hereinafter, embodiments of the present invention will be described with reference to the drawings. FIGS. 1 to 4 illustrate an embodiment of a microphone holder according to the present invention. FIG. 1 is a perspective view illustrating a state in which a microphone holder according to the present invention is mounted to a tom-tom. FIG. 2 is a sectional view of a state in which a microphone of the present invention is mounted to a tom-tom. Further, FIG. 3 is a perspective view of the microphone holder according to the present invention, as viewed from the front, and FIG. 4 is a perspective view, as viewed from the rear. Note that FIGS. 1 to 4 illustrate a state of holding the microphone.

In a tom-tom 20, as illustrated in FIG. 1, a metal ring-like rim 22 is provided over a periphery of a drum head 21, and the rim 22 is attached to a drum shell 24 (hereinafter, also called shell) at a plurality of supporting portions 23 provided along the circumferential direction by tension bolts 25. More in detail, a plurality of tension bolts 25 is respectively screwed into a plurality of lugs 26 provided on an outer circumferential surface of the drum shell 24, and the pressing amount of the rim 22 against the shell 24 is set according to the degree of tightening. As illustrated in FIG. 2, a ring-like head peripheral member 27 is provided on a peripheral portion of the drum head 21. An upper surface of the head peripheral member 27 is pressed by the rim 22, so that the tension of the drum head 21 is adjusted (tuned).

A microphone holder 1 is mounted to one of the plurality of tension bolts 25. The tension bolt 25 is a stick-like member with a predetermined threaded circumferential area, and a bolt head 25a is provided on a head portion thereof. As illustrated in FIG. 2, the tension bolt 25 is downwardly inserted into a through hole 23a of a supporting portion 23, the supporting portion 23 protruding on an outer circumferential portion of the rim 22 in a radially outward direction, and a lower face side of the bolt head 25a is rotatably engaged with a peripheral portion of the through hole 23a around a shaft through a nut 28. Therefore, the bolt head 25a is arranged in a state of protruding above the supporting portion 23.

In addition, a distal end of the tension bolt 25 is screwed into the lug 26 provided on the outer circumferential surface of the shell 24, as described above. By turning the bolt head 25a to screw the distal end side of the tension bolt 25 into the lug 26, the supporting portion 23 is pressed downward. That is, the rim 22 is pressed downward, and the tension of the drum head 21 becomes high.

As illustrated in FIGS. 2 and 3, the microphone holder 1 roughly includes a mounting portion 2A to the drum, and a holding portion 2B that holds a microphone 30.

The mounting portion 2A has a first clip member 3 that has a plate member 4 as a substrate, the plate member 4 having a rectangular shape in plan view, for example. The first clip member 3 includes the plate member 4 with an upper face (abutting surface portion) subjected to anti-slipping processing by rubber coating, and a locking notch 4a formed into a U shape cut from one side surface side to a central portion of the plate. The width of the locking notch 4a is formed to be able to hold a shaft portion of the stick-like tension bolt 25.

The mounting portion 2A has a second clip member 6 disposed above the first clip member 3. In the second clip member 6, an insertion hole 5a, into which the bolt head 25a that is a head portion of the tension bolt 25 is inserted from a lower side, is formed in the plate member 5 that serves as a substrate.

As illustrated in FIGS. 3 and 4, the first clip member 3 and the second clip member 6 are respectively formed in distal end portions of a pair of long plate-like clamping members 7 and 8. In the vicinity of a central portion of the clamping member 7, a pair of support shaft portions 7a is installed in a standing manner from both right and left ends, and in the vicinity of a central portion of the clamping member 8, a pair of support shaft portions 8a is installed in a standing manner from both right and left ends. The pairs of support shaft portions 7a and 8a face each other, and the pair of support shaft portions 7a is arranged to overlap with insides of the pair of support shaft portions 8a. Further, shaft holes 7a1 and 8a1 are coaxially provided in the pairs of support shaft portions 7a and 8a. A shaft arm 35 is inserted into the shaft holes 7a1 and 8a1, so that the clamping members 7 and 8 are rotatably coupled in a state of facing each other, having the shaft arm 35 as a support shaft.

Further, as illustrated in FIG. 2, a coil spring 36 is arranged between the pairs of clamping members 7 and 8, and the shaft arm. 35 is arranged in a cylindrical coil portion 36a. One end portion 36b and the other end portion 36c extending in a stick like manner, of the coil spring 36, abut on rear surfaces of the clamping members 7 and 8, respectively.

Further, a pair of gripping portions 7b and 8b biased in a direction of being away from each other by the coil spring 36 is formed at sides of the pairs of clamping members 7 and 8, where the first clip member 3 and the second clip member 6 are not provided, across the support shaft portions 7a and 8a. By pinching the pair of gripping portions 7b and 8b with fingers, the first clip member 3 and the second clip member 6 are moved in a direction of being away from each other, having the shaft arm 35 as a support shaft. Further, by releasing the fingers from the gripping portions 7b and 8b in a state of being held with the fingers, the first clip member 3 and the second clip member 6 are again moved in a direction of coming close to each other by biasing force of the coil spring 36.

Further, a supporting portion 15 for supporting the microphone 30 is provided at a side portion of the mounting portion 2A, as a holding portion 2B.

Here, the held microphone 30 includes a microphone main body 30a, a cable 30b, and a flexible arm 31 that supports the microphone main body 30a and the cable 30b. The supporting portion 15 is formed into a tubular shape with a bottom, and a lower end portion of the flexible arm 31 is fit into the supporting portion 15, and the microphone 30 is held by the microphone holder 1.

To set the microphone holder 1 configured as described above to the tom-tom 20 to mount the microphone 30, the pair of gripping portions 7b and 8b is pinched with fingers to widen a separation distance between the first clip member 3 and the second clip member 6, having the shaft arm 35 as a support shaft.

Next, in that state, the locking notch 4a of the first clip member 3 is engaged with the shaft portion of the tension bolt 25 positioned at a lower side of the supporting portion 23 of the rim 22 (the shaft portion of the tension bolt 25 is held by the locking notch 4a).

Further, in this state, the insertion hole 5a of the second clip member 6 is moved above the bolt head 25a, and the fingers that hold the pair of gripping portions 7b and 8b are released, so that the second clip member 6 is moved in the direction of coming close to the first clip member 3.

Accordingly, the bolt head 25a of the tension bolt 25 is inserted into the insertion hole 5a from a lower side, as illustrated in FIGS. 1 and 2, and the upper face of the plate member 4 of the first clip member 3 abuts on a lower face of the supporting portion 23 of the rim 22, and the first clip member 3 and the second clip member 6 clamp the rim 22 and the bolt head 25a, in the state where the locking notch 4a of the first clip member 3 holds the shaft portion of the tension bolt 25. Accordingly the microphone holder 1 is fixed to the tension bolt 25.

When the microphone holder 1 is fixed to the tension bolt 25 as described above, the flexible arm 31 is fit into the supporting portion 15 and fixed thereto, so that the microphone 30 is held by the microphone holder 1.

According to the embodiment of the microphone holder according to the present invention, the microphone holder 1 is fixed to the tension bolt 25 that adjusts the tension of the drum head 21, with the first clip member 3 and the second clip member 6.

That is, the weight of the microphone is not loaded on the rim, and thus tuning of the drum and sound collection can be performed without adversely affect the tension of the drum head.

Note that, in the embodiment, a configuration in which the microphone holder 1 is engaged with the tension bolt 25 and the supporting portion, and the microphone holder 1 is mounted to a tom-tom, accordingly has been employed. However, the microphone holder 1 may be rotated around the shaft of the tension bolt 25 after mounted.

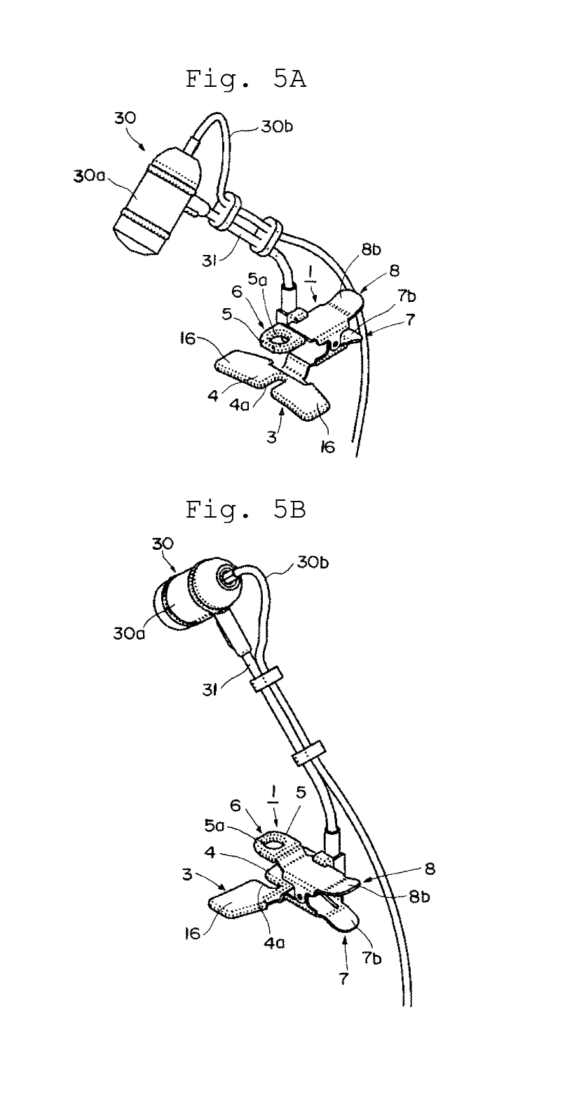

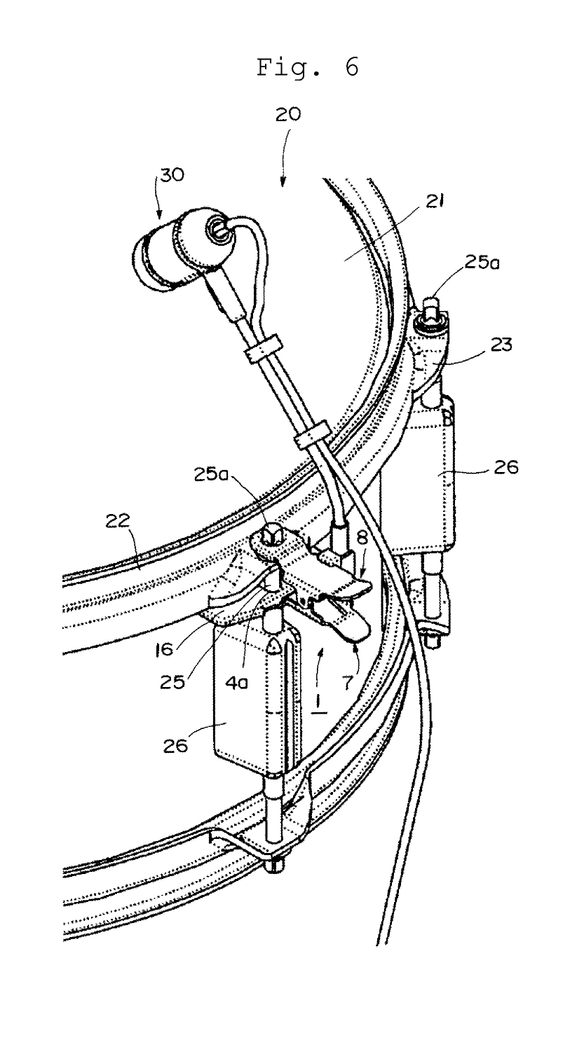

Therefore, as illustrated in the perspective views of FIGS. 5A and 5B, it is favorable to provide a pair of support leg portions 16, which is formed in a flange manner, and extends from both right and left sides of the plate member 4 of the first clip member 3 toward the rim side, and to cause distal end sides of the support leg portions 16 to abut on the rim 22 and the shell 24, as illustrated in FIG. 6. With such a configuration, the microphone holder 1 can be mounted in a more stable state, and can be prevented from being rotated around the shaft of the tension bolt 25.

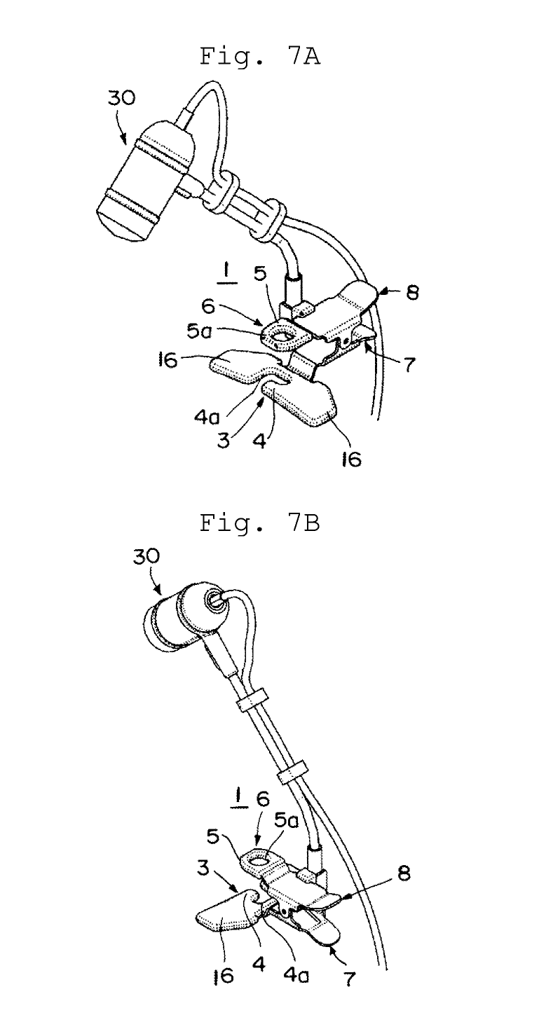

Further, when the support leg portions 16 are provided in the first clip member 3, as described above, the first clip member 3 has a width in a right and left direction with respect to the drum, due to the support leg portions 16. Therefore, the locking notch 4a may be formed into a hook manner, as illustrated in FIGS. 7A and 7B.

With such a configuration, the microphone holder 1 can be in a locked state of being less likely to come off of the tension bolt 25, as illustrated in FIG. 8.

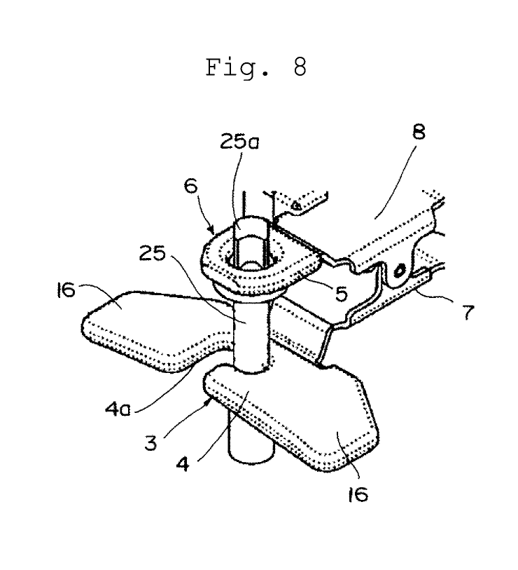

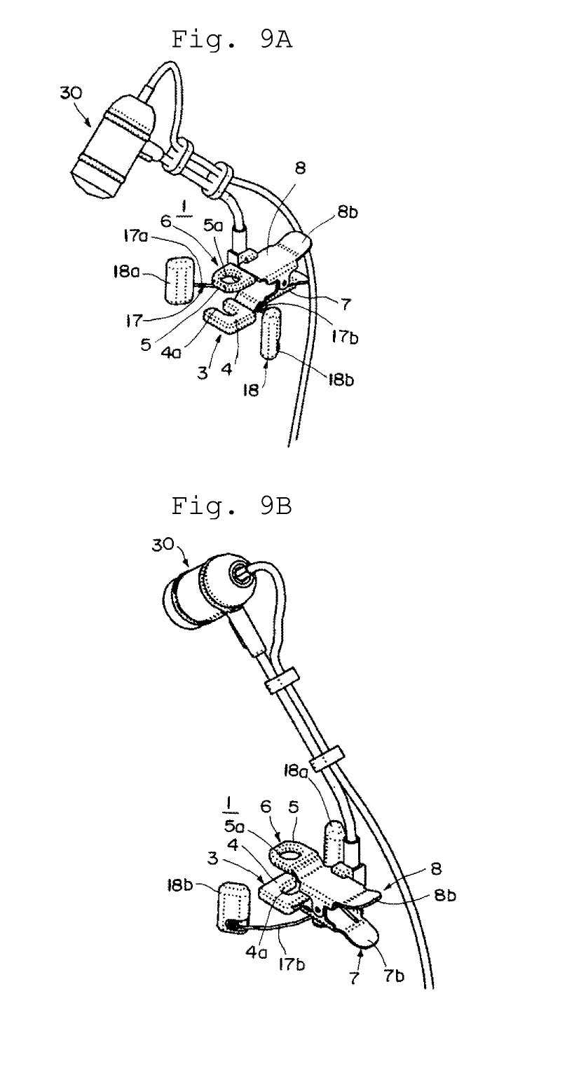

Alternatively, as illustrated in the perspective views of FIGS. 9A and 9B, a support leg portion 18 using a coil spring 17 having a stick-like long leg portions 17a and 17b (arm members) may be included (instead pf the support leg portions 16). In the support leg portion 18, a coil portion (not illustrated) of the coil spring 17 is arranged at the second clip member 6 side, for example, abutting members 18a and 18b for the rim are provided on distal ends of the stick-like long leg portions 17a and 17b, and the abutting members 18a and 18b are arranged to the right and left of the first and second clip members 3 and 6, respectively.

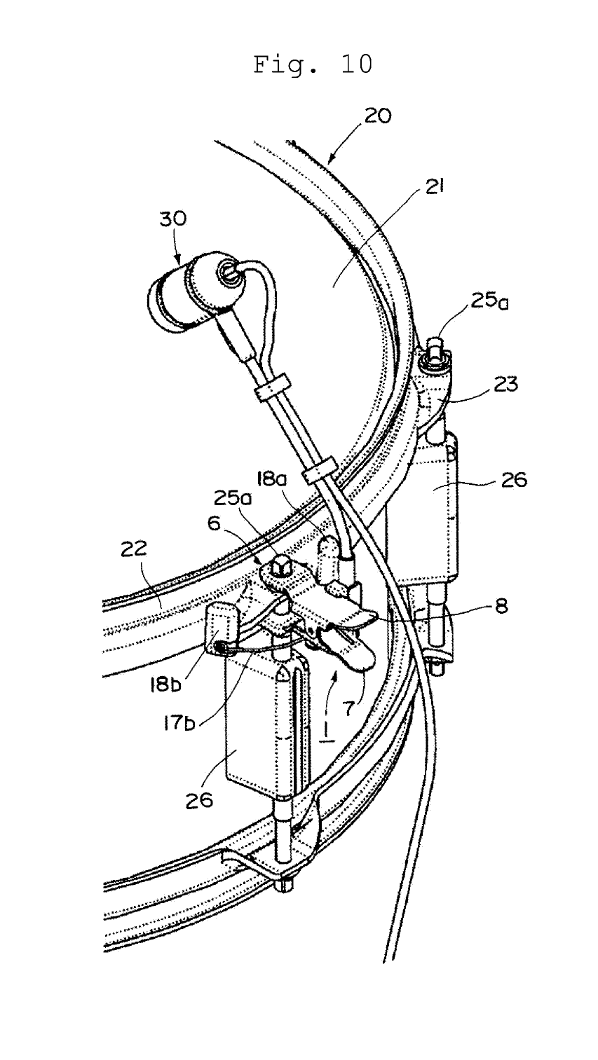

In doing so, when the microphone holder 1 is mounted to the tom-tom, as illustrated in FIG. 10, the abutting members 18a and 18b abut on the rim in a state of being biased by elastic force of the coil spring 17. Therefore, vibration transmitted from the tom-tom. 20 to the microphone holder 1 (microphone 30) can be absorbed.

Further, in the embodiment, an example of mounting the microphone holder 1 to the tom-tom 20 has been described. However, the microphone holder 1 can be favorably used for a snare drum. Further, the microphone holder 1 can be favorably used for other types of drums as long as these other types of drums have the rim and the tension bolt.

Further, the microphone holder 1 according to the present invention can be mounted to instruments other than the drum, depending on the shapes of the clamping members 7 and 8.

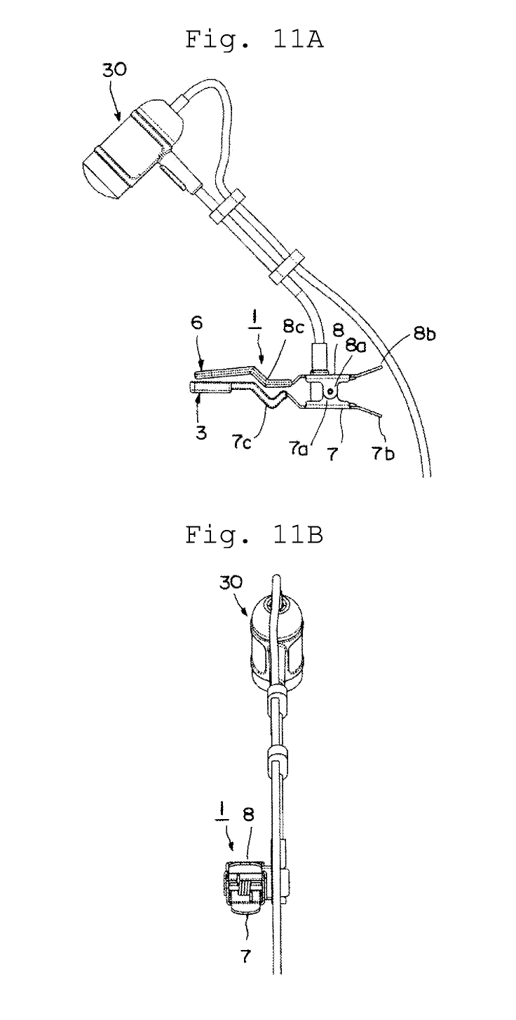

For example, as illustrated in FIGS. 11A to 11C, in the clamping members 7 and 8, step portions 7c and 8c as illustrated may be included in the shape between the first clip member 3 and the second clip member 6, and the support shaft portion.

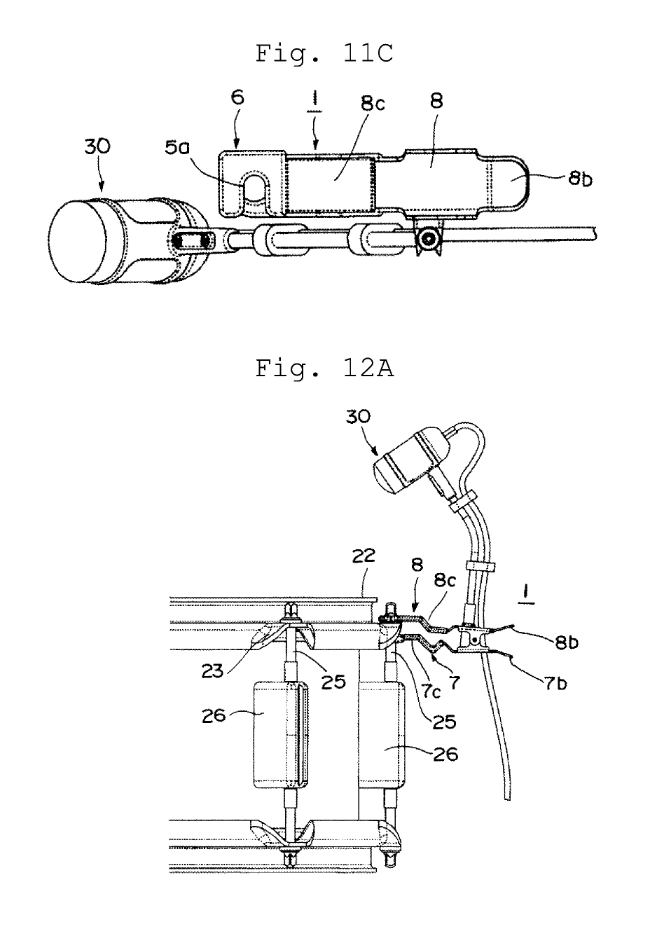

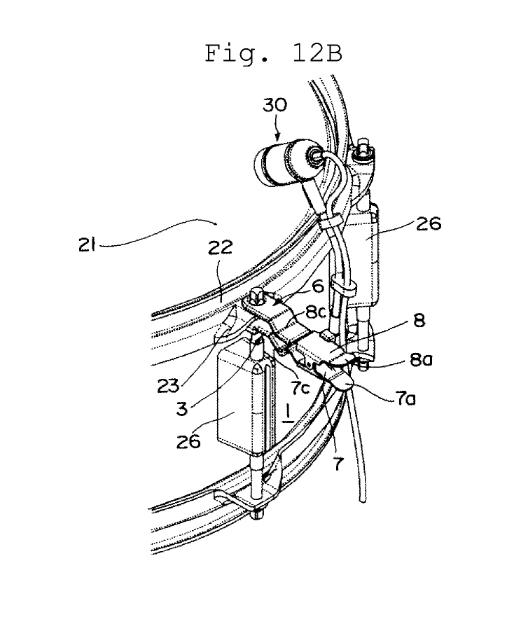

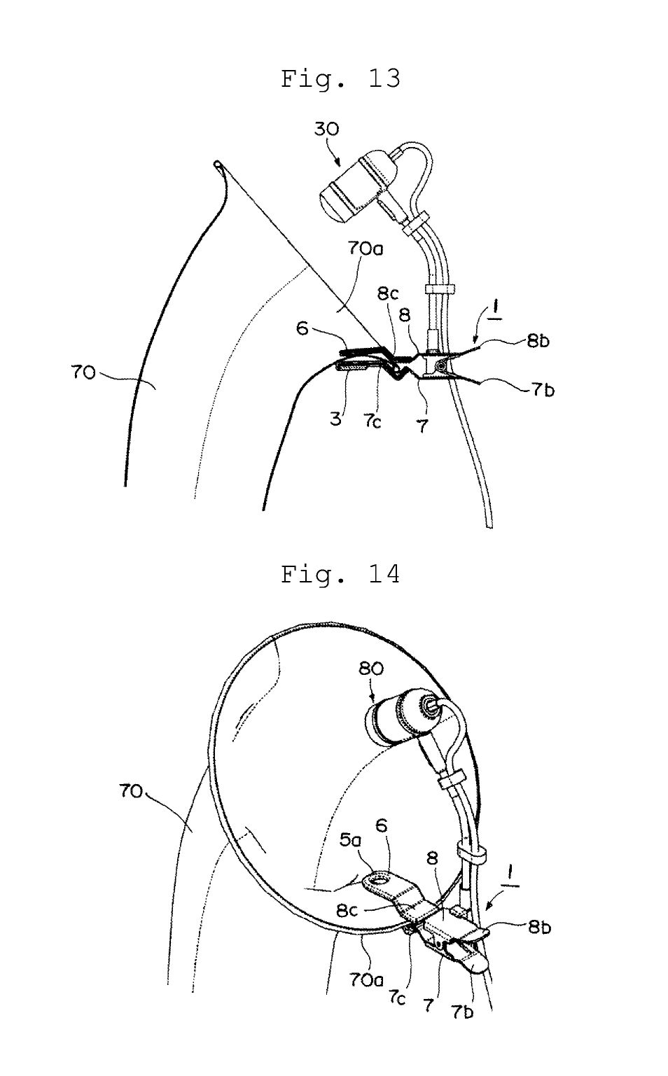

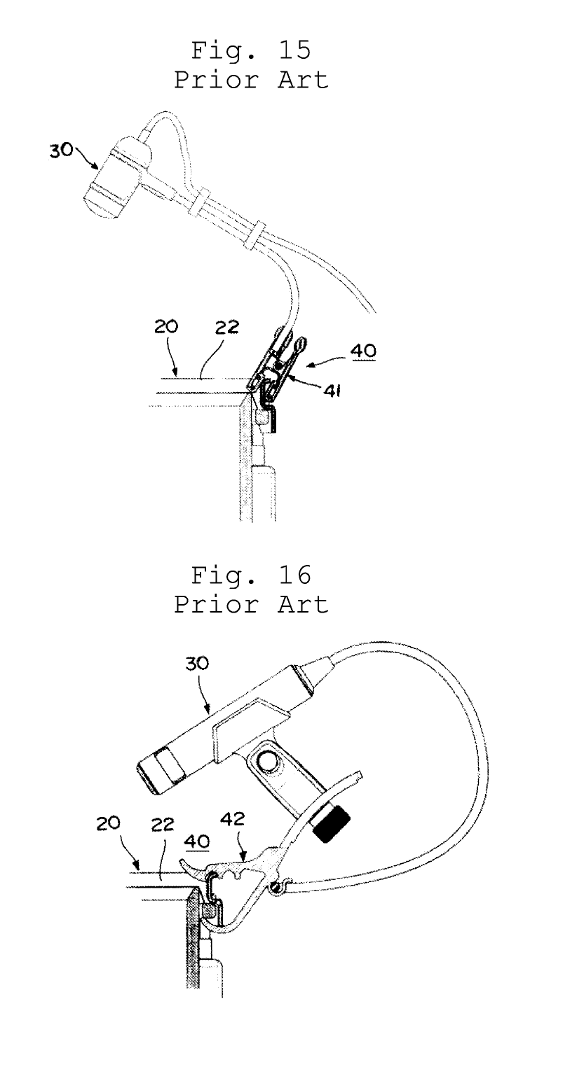

In this case, the microphone holder 1 can be mounted to a rim portion of a drum, as illustrated in FIGS. 12A and 12B. Further, the microphone holder 1 can be mounted using the step portions as illustrated in FIGS. 13 and 14, in a state of holding a horn opening edge portion 70a of a wind instrument 70, and being stabilized with a plurality of fulcrums.

What is claimed is:

1. A microphone holder comprising:
a holding portion adapted to hold a microphone; and
a mounting portion coupled with the holding portion, and adapted to be mounted to a tension bolt for fixing a rim of a drum,
the mounting portion including
a first clip member including a plate member adapted to be locked with a lower face side of the rim, and a locking notch formed in the plate member and adapted to be locked with a shaft portion of the tension bolt,
a second clip member arranged above the first clip member, and including an insertion hole into which a head portion side of the tension bolt is inserted and locked, and
a clip mechanism in which a pair of clamping members having the first clip member and the second clip member respectively formed in distal end portions, and arranged to face each other is rotatable around a support shaft provided between the pair of clamping members, and the first clip member and the second clip member are biased in a direction of coming close to each other.

2. The microphone holder according to claim 1, wherein the locking notch included in the first clip member is a notch formed from one side surface side of the plate member.

3. The microphone holder according to claim 1, further comprising:
a pair of support leg portions provided in both right and left sides of the plate member of the first clip member, and adapted to abut on and support the drum side.

4. The microphone holder according to claim 3, wherein the pair of support leg portions is formed of flanges provided extending from the both right and left sides of the plate member of the first clip member.

5. The microphone holder according to claim 3, wherein the pair of support leg portions includes a pair of arm members having elasticity and provided extending from the first clip member side to the both right and left sides of the plate member, and a pair of abutting members provided on distal ends of the arm members.

6. The microphone holder according to claim 3, wherein the locking notch is formed into a hook manner.

7. The microphone holder according to claim 1, in the clamping members, step portions is included in the shape between the first clip member and the second clip member, and the support shaft portion.
